(19) United States
(12) Patent Application Publication
(10) Pub. No.: US 2023/0048698 A1
(43) Pub. Date: Feb. 16, 2023

(54) FULL CONTROL OF VEHICLE MOTION

(71) Applicant: Eyup AYAN, Carsamba (TR)

(72) Inventor: Eyup AYAN, Carsamba (TR)

(21) Appl. No.: 17/791,529

(22) PCT Filed: Jan. 10, 2020
(86) PCT No.: PCT/TR2020/050018

§ 371 Date: Jul. 7, 2022

(51) Int. Cl. B60K 17/34; B60K 17/08; B60K 1/00

(52) U.S. Cl. CPC B60K 17/34; B60K 17/08; B60K 1/00

(57) ABSTRACT

The invention can be applied to its specific vehicle types. Control unit (16) adjusts the shaft rotation speed of electric motor 1(13) and electric motor 2(15) in accordance with driving control data (17). While electric motor 1(13) is responsible for forward-backward motion of the vehicle, electric motor 2(15) provides right-left cornering to the vehicle. This cornering is made possible with the change in rotational speed between side wheels (2,3). Directional control via the side wheels (2,3) will not be sufficient for vehicle control at high speeds. For this purpose, a hydraulic system functioning dependent to the side wheels (2,3) is formed. The pulling force generated between the hydraulic cylinder (20) and the end of the hydraulic piston rod (20a) is used to control the direction of the front wheel (1) and/or rear wheel (4) of the vehicle.

### FIELD OF THE INVENTION

This invention relates to a vehicle having a right wheel and left wheel on the right side and the left side of the vehicle respectively, and/or a front wheel in the front side of the vehicle that can turn to any direction (360°), and/or rear wheel in the back side of the vehicle that can turn to any direction (360°). While these systems provide the speed control of the vehicle on the side wheels (right and left wheel) for the vehicle's motion and direction change, they enable the turning of the front and/or rear wheels in the desired direction in connection with the side wheels at the same time.

### PRIOR ART DOCUMENTS

### Patent Documents

[Patent Document 1] CN 1304237 C
[Patent Document 2] US 20120109484A1
[Patent Document 3] WO2016/199521 A1
[Patent Document 4] US9243700 B1
[Patent Document 5] WO 2018/122460 A1
[Patent Document 6] EP 1764253 A1
[Patent Document 7] U.S. Pat. No. 4,917,200 A
[Patent Document 8] JP S59 78181 U

### BACKGROUND OF THE INVENTION

Patent document 1 and patent document 2, steering of the vehicles is made on the front and/or rear wheels and causes more material usage. Also the vehicles can not turn around itself axis.

Worm gears used in the input sections included in patent document 3 provide speed control for low speeds. The aim is to achieve high torque. While achieving high torque, low speed is gained. If such mechanism is applied on the vehicle, the forward-backward motion of the vehicle would be at insufficiently low speeds. Also, mechanic energy amount transferred in the vehicle system for forward-backward motion is high level. If forward-backward motion here is transferred through worm gears, energy efficiency would be low. Because, energy transfer efficiency of worm gears is low due to friction. In addition to serious energy waste, mechanical wearings due to mechanical frictions would create unnecessary problem. Using such invention in the system we need is quite insufficient and problematic.

In patent document 4, there is a worm gear assembly having a gear ratio of between about 3:1 and about 1.4:1. Therefore, the power of the control motor must be at a high level that is almost at the level of the power applied from the other input. When this condition is not important, patent document 4 can be applied. However, if the control motor, which provides the direction control of the vehicle in the scope of the invention, is almost as big as the main motor providing forward-backward motion to the vehicle, this will be a problem because of cost, weight and volume. Moreover, rotary speed of the control motor will cause speed change at serious rates on the output. Although this is acceptable when serious-high changes are required, it is not acceptable for our system for which sensitive-low speeds are required. Another detail is that, the low gear ratio, with the more powerful control motor, increases the force applied on the worm gear assembly, thus, causing mechanical durability problem. Therefore, worm gear is applied from both sides in the patent document 4 and extra gears are used. Extra gears used here is necessary for the work of related invention, however, when the operation principle of our system is considered, they would be unnecessary. In general, using such invention in the system we need is quite insufficient and problematic.

In Patent document 5, Patent document 6, and Patent document 7, the mechanical power needed to provide the vehicle's forward-backward motion is generated in a distant point and transferred to the planetary mechanism through transmission parts (bevel gear, sprocket, gear set, etc.). Energy losses in these transmission parts (bevel gear, sprocket, gear set, etc.) and the fact that the system includes additional unnecessary parts creates drawbacks in many ways (efficiency, cost, maintenance, breakdowns, weight, etc.). In this present invention, as the mechanical power that is necessary for the vehicle's forward-backward motion is generated at a point near side wheels, unnecessary transmission parts (bevel gear, sprocket, gear set, etc.) are not employed.

In addition, the use of components such as two control motors and their worm gear set in Patent document 5, Patent document 6 and Patent document 7, increases the number of equipment. In addition, increasing the number of control motors will increase the equipment (motor driver, etc.) in the control unit. The multiplicity of system components will increase the risk of failure as well as problems such as cost. Failure can be dangerous if this part is to take an active role in such an important function as direction control.

When the patent document 5 is reviewed in detail, the direction control in this application is made by the angular direction change of the front wheels of the vehicle. On the other hand, the wheels to which power is transmitted provide less rotation of the inner wheels in accordance with the change of direction of the vehicle. In short, generation of a more controllable differential gearbox is aimed. While transmitting the power necessary for the vehicle's motion to the side wheels, its adaptation to direction change of the vehicle is aimed. In this sense, the elements mentioned in the related patent are not the ones that are responsible for the direction control but only the accommodative elements. The biggest problem of this system, which does not match the system we developed in related subject matter, is that two control motors must always work in harmony with the front wheels that determine the direction of the vehicle. The control unit will manage two control motors. In addition to doubling the risk of malfunctions, such control can cause the electronic communication delay that may occur in this section. Or, any error due to the use of the steering mechanical device or the sensors which express the angle of rotation of the front wheels can cause the vehicle to move as if it is without differential gearbox. Thus, it is a dangerous situation. In short, it will be technically more risky and costly to use this system as an alternative to the conventional differential that tolerates more flexible potential errors while becoming a system that must work in a one-to-one correspondence with the vehicle's angle of turning.

If we examine the planetary mechanism developed in Patent document 5 in particular, the shaft mounted to the worm gear that will be rotated by the control motor is without a bearing. When the frictions during the rotation of this shaft are considered, these shafts' being supported with bearings is important. As a different point, worm gear and planetary gears are not in the same plane (Patent document 5 FIG. 2a). Since the force received by the worm gear will be conveyed to the planetary gears, the fact that these two elements are not in the same axis will increase the pressure and the force on the bearings. In addition to energy losses, the ring gear will be subjected to a force that can cause misalignment of its mounting position.

As a separate point in patent document 5, one planetary carrier is used and the output for the rotation of the wheel is received over it. The torque value is high because it is the output part. When transferring force from one side to the planetary carrier only on the rods on which the planetary gears are mounted, it will create serious pressure on the mechanical connection between the planetary gears' rods and the planetary carrier. The fact that the planet carrier and the planetary gears are not in the same plane will further increase the pressure on the physically specified part. It is useful to alleviate such pressures to ensure long-term and problem-free operation of the mechanisms.

Another point in Patent document 5 is that there is only one bearing on the outlet fixed to the planet carrier (patent document 5 FIG. 2a). As it is mentioned earlier, since this is the output part, torque and force values are high. The planetary gears apply force from the position that would disrupt the working position of the output shaft. In addition, if we also consider the working gap that should be at the contact parts of the gears, the output shaft must be mounted with the bearing from at least two points. Output parts of planetary mechanism in Patent document 5 are also insufficient.

The focus of the subjects developed in Patent document 6 and Patent document 7 is crawler type vehicles. The special conditions for this are generally high torque and low speeds. Therefore, to achieve a high torque, many transmission parts are used. However, in addition to being unnecessary for this wheeled-land vehicle, it will have negative sides such as weight and energy losses. Crawler type vehicles move at a lower speed than road vehicles with tires. Failure-problems that can also be caused due to controlling with more elements on the side wheels may not be vital at low speeds. The crawler type vehicle can be stopped in the event of a failure-problem. However, the situation will be more dangerous for a high speed land vehicle. In general, having fewer and more robust transmission parts and control elements would be an ideal solution for the wheeled land vehicles.

Patent document 8 is designed for wheeled land vehicle. For this reason, the managerial simplicity has been thought by taking into consideration the risk of problem-failure that can be caused by two control motors mentioned in the previous patent documents. Thus, only one control motor is used. Mechanical energy generated by this motor is conveyed to two side wheels by transmission parts. Too many gear sets are used here. In the control section, while the risk of managerial error is reduced, the risk of mechanical failure is increased. In addition, the mechanical components (gears, transmission shafts) in this section are not a good solution when vehicle weight, manufacture, assembly, maintenance are considered.

In Patent document 8, many gears are used to transfer power to the wheels of the main engine that will move the vehicle forward-backward. In each application alternative (FIG. 1, FIG. 2, FIG. 3 in Patent document 8), the bevel gear is used for the main power transfer for forward and backward movement of the vehicle. Energy efficiency is important because there will be a high energy flow from this power transfer. The efficiency of bevel gears are lower than spur gears. This is because the bevel gear stage generates high axial and radial forces. This force must be absorbed by bearings and support parts. Therefore, loss of power and energy increases. In short, using a large number of bevel gears and spur gears will cause negativity in many aspects such as energy efficiency, production cost, weight and maintenance.

Another problem in patent document 8 is that the worm gear set is not used to transfer the rotation of the control motor. The self-locking feature of the worm gear set eliminates the need for braking. Therefore, in this application, an additional brake unit will be required for the control motor. Otherwise, when the control motor is not rotating (idle), the power of the main motor is transferred to this part and causes the control motor shaft to rotate, which leads to an error in the direction control. Briefly, the additional brake unit for the control motor will form an additional equipment surplus.

In Patent document 8, the side wheels are mounted to the sun gear of the planetary gears (FIG. 3 in Patent document 8). Here planet gears are used reversely with reference to input-output parts. In other words, the speed of rotation coming to the planet gears increases while they are being transferred to the wheels. In general, planetary gears are used to reduce the rotation speed and thus torque increases. However, in the related patent (FIG. 3 in Patent document 8), the torque of the main motor, which will move the vehicle forward and backward, is increased by the bevel gear. And then, the torque in planetary gear is reduced. Such opposing applications are less efficient and meaningless. This situation can be improved with a better system, and some components will also not need to be used.

### Problems to be Solved by this Invention

Too many mechanical elements (bevel gear, sprocket, gear set, etc.) used in previous similar patents to transmit main power from the engine to the wheels for forward and backward movement of the vehicle have been reduced. Therefore, energy efficiency has been increased.

In the previous patents, the number of materials-equipment used in changing the direction of the vehicle is quite high and with the present invention a simpler and safer system with fewer parts has been established.

A new mechanism called ‘addition reducer’ has been created by considering the inadequacies and disadvantages of the previous techniques as well as the mechanical durability of the planetary-like mechanism that should be used in order to change the speed on the side wheels of the vehicle.

In the aforementioned vehicle versions, at high speeds (over 40 km/h) it is not safe to provide the direction control of the vehicle only through the side wheels. To make it safe, the front and/or rear wheels are also provided with an angular turning position dependent on the side wheels without an independent control system (in order to reduce the risk of accidents and to provide a more ideal solution).

Briefly, a highly energy-efficient integrity of the systems, which can turn around its own axis and provide reliable vehicle movement control at high speeds by using as little material-equipment as possible is established.

With the advantages expressed in general, the invention provides a number of interrelated benefits such as weight, efficiency, cost, maintenance, and duration of manufacture of the vehicle.

### BRIEF DESCRIPTION OF THE DRAWINGS

FIG. 1: View set from the top for the wheels of alternative vehicle models to which the invention can be applied.

FIG. 2: Detailed drawing of mounting-demounting of twin, front wheel (1) and/or rear wheel (4) through front-rear wheel mounting support (5).

FIG. 3: Detailed drawing of mounting of single, front wheel (1) and/or rear wheel (4) through front-rear wheel mounting support (5).

FIG. 4: Perspective drawing of mechanical parts providing the mechanical connection between the vehicle and left wheel (2) and right wheel (3).

FIG. 5: Perspective drawing of mechanical parts providing the mechanical connection between the vehicle and front wheel (1) and/or rear wheel (4).

FIG. 6 is set of drawing explaining the vehicle's turning logic.

FIG. 7 is set of drawing of the essential parts responsible for the motion of the vehicle.

FIG. 8: Assembly details of parts fixed on AR cylinder (14f).

FIG. 9: Mounting parts of AR planet gears (14k) are shown.

FIG. 10: perspective drawing of mounted positions between AR input 1 (14a), AR planet carrier (14h), AR planet carrier rod (14i), AR planet gears (14k), AR support rod (14p) and AR sun gear (14l).

FIG. 11: Drawing showing mounting relations between AR planet carrier rod (14i), AR support rod (14p), AR planet carrier (14h) and AR planet gears (14k).

FIG. 12: Drawing showing mounting relations between AR input 1 (14a), AR planet carrier (14h), AR support rod (14p), AR planet carrier rod (14i), AR planet gears (14k) and AR sun gear (14l).

FIG. 13: Drawing of mounting direction of AR cylinder (14f) and its fixed parts with AR input 1 (14a) and AR planet gears (14k).

FIG. 14: Perspective drawing showing mounting details inside the half visible image of AR cylinder (14f) and its fixed parts.

FIG. 15: Drawing showing fixed position of AR worm wheel (14j) on AR planet carrier (14h); and AR worm gear (14m) whose threaded sides are in contact with AR worm wheel (14j).

FIG. 16: Drawing of AR body bearings (14r) providing mounting of AR input 1 (14a), AR input 2 (14b) and AR output (14c) with AR body (14d).

FIG. 17: In the alternative version of Addition reducer (14), AR output (14c) and AR planet carrier (14h) are fixed to each other, the mounting detail of AR planet gears (14k) to AR planet carrier (14h) through AR planet carrier rod (14i).

FIG. 18: In the alternative version of Addition reducer 1 (14), drawing showing mounting detail of AR input (14a) and AR sun gear (14l) which are fixed to each other in a way so that it provides a threaded contact between AR sun gear (14l) and AR planet gears (14k).

FIG. 19: In the alternative version of Addition reducer (14), drawing showing the mounting details of AR ring gear (14n), AR worm wheel (14j), AR worm gear (14m) and AR input 2 (14b) parts.

FIG. 20: Detailed drawing of AR ring gear support (14s) and AR circlip channel (14t).

FIG. 21: Detailed drawing of AR support bearing (14u) assembly.

FIG. 22: AR body bearings (14r) used in alternative version of addition reducer (14) mechanism.

FIG. 23: Drawing of two different versions of Addition reducer (14) depending on shaft type.

FIG. 24: System to transfer mechanical power to hydraulic pump (19).

FIG. 25: Vertical view of the parts employed in the functioning of hydraulic cylinder (20).

FIG. 26: Perspective drawing of the parts employed in the functioning of hydraulic cylinder (20).

FIG. 27: Detailed drawing of the parts employed in the functioning of hydraulic cylinder (20) for the front and rear side.

FIG. 28: Parameters on which angle (x) is dependent.

FIG. 29: Mounted drawing of rope (22) stretching elements.

FIG. 30: Schematic drawing of hydraulic system.

FIG. 31: Schematic drawing showing the operation of vehicle control in the electrical and electronical environment.

FIG. 32: Set of side views are schematically shown for alternative vehicle versions to which the invention can be applied.

### DESCRIPTION OF THE REFERENCES IN THE DRAWINGS

1: front wheel
2: left wheel
3: right wheel
4: rear wheel
5: front-rear wheel mounting support
5a: front-rear wheel steering handle
6: front-rear wishbone
7: suspension
8: vehicle body
9: side wishbone
10: sliding cardan shaft
11: hub apparatus
12: speed reducer
13: electric motor 1
14: Addition reducer (AR)
14a: AR input 1
14b: AR input 2
14c: AR output
14d: AR body
14e: AR bearing
14f: AR cylinder
14g: AR cylinder bearing hole
14h: AR planet carrier
14i: AR planet carrier rod
14j: AR worm wheel
14k: AR planet gears
14l: AR sun gear
14m: AR worm gear
14n: AR ring gear
14p: AR support rod
14r: AR body bearing
145: AR ring gear support
14t: AR circlip channel
14u: AR support bearing
14v: AR circlip
15: electric motor 2
16: control unit
17: driving control data
18: belt pulley with one-way bearing
18a: belt
18b: belt pulley
19: hydraulic pump
20: hydraulic cylinder
20a: hydraulic piston rod
21: linear rail
22: rope
23: piece with bearing
24: pulley
25: mobile pulley
26: spring
26a: spring's rope
27: fixed throttle valve
28: filter
29: reservoir
x: angle
y: vehicle width
z: vehicle half-length
V1: EM1 wheel rpm (Rotation speed generated by Electric motor 1 on the wheels (2, 3))
V2: EM2 wheel rpm (Rotation speed difference generated by Electric motor 2 on the right wheel (3))

### DETAILED DESCRIPTION

Since the invention is extremely complicated, its description is mainly explained through going from part to whole method. It is hard to explore the invention as a whole because there are many parts and equipments and they are interlocked with each other. To provide better understanding of the invention, we isolated components that are not related at that point in our drawings in the figures. Having explained all these details one by one, it will be easier to understand the invention as a whole.

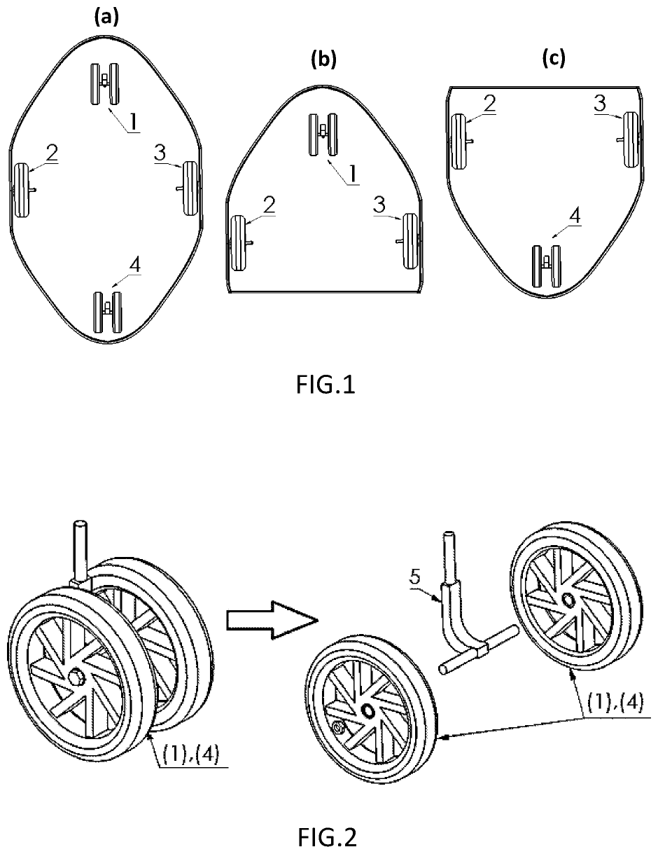

Arrangements and positions of the wheels on the vehicles to which the invention is applied must be in a specified order. These arrangement variations are explained in FIG. 1. FIG. 1a shows a front wheel (1) in front of the vehicle, a left wheel (2) and a right wheel (3) on the left and right sides of the vehicle respectively, and a rear wheel (4) on the rear of the vehicle. For vehicles with this wheel arrangement, the invention can function effectively. FIG. 1b shows the front wheel (1) in front of the vehicle, and left wheel (2) and right wheel (3) on the left and right sides of the rear part of the vehicle respectively. For vehicles with this wheel arrangement, the invention can function effectively. FIG. 1c shows the left wheel (2) and the right wheel (3) on the front left and front right sides of the vehicle respectively, and the rear wheel (4) on the rear part of the vehicle. For vehicles with this wheel arrangement, the invention can function effectively.

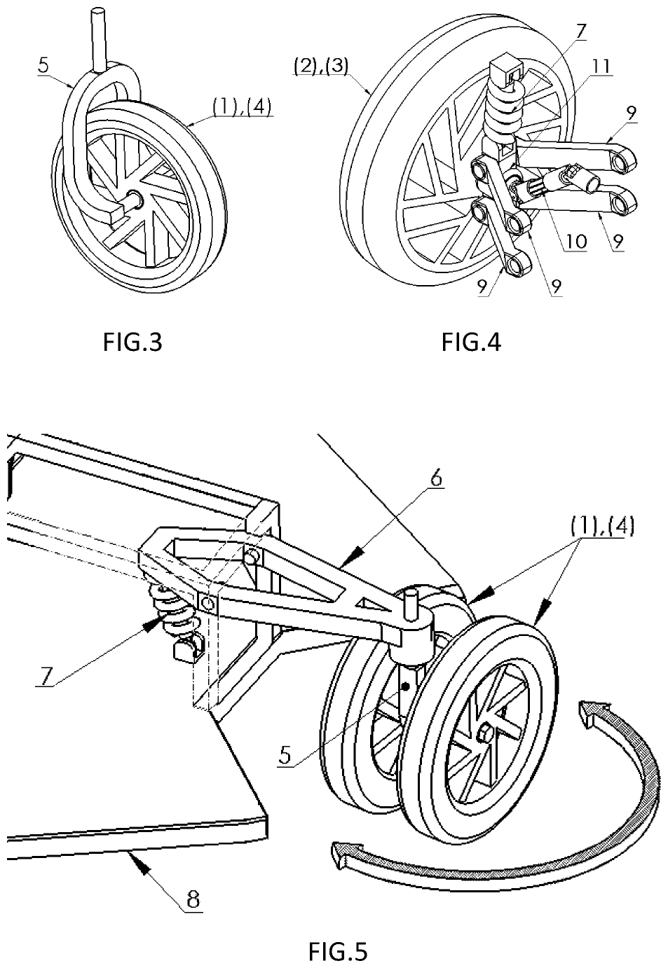

FIG. 2 shows the mounting-demounting detail of the twin front wheel (1) and/or rear wheel (4) with front-rear wheel mounting support (5). Here, it is particularly important that the front-rear wheel mounting support (5) is inclined in the vertical to horizontal direction. In this way, the wheels (1, 4) can be oriented in accordance with the direction of movement of the vehicle. FIG. 3 shows the mounting details of the single front wheel (1) and/or single rear wheel (4) with the front-rear wheel mounting support (5). The front wheel (1) and/or the rear wheels (4) are often shown as twin wheels. However, they do not have to be twin. In FIG. 3, the single wheel variation is explained. This will change the structure of the front-rear wheel mounting support (5) as well. FIG. 3 expresses the mounting details of the single front wheel (1) and/or single rear wheel (4) with the front-rear wheel mounting support (5).

In FIG. 4, it is attempted to express the mechanical parts which show the mechanical contact of the left wheel (2) and the right wheel (3) to the vehicle. Applications similar to those described in this section are commonly used in the world. The left wheel (2) and the right wheel (3) are attached to the vehicle body (8) by side wishbones (9). The mounting of the side wishbones (9) to the vehicle body (8) can be carried out with the rod, and side wishbones (9) can turn around this rod. This rotational movement allows the oscillating movements of the side wishbones (9) in the vertical position. The hub apparatus (11) allows the side wishbones (9) to hold on the shaft of the left wheel (2) and the right wheel (3) which are rotatable. This is because the bearing type inner structure of the hub apparatus (11) makes the rotation of the shafts coming from the center of the wheels (2, 3) problem free. These shafts are subsequently coupled with a sliding cardan shaft (10). In addition, the suspension (7) shown in FIG. 4 is responsible for reducing the vibrations to be caused by the road defects. One side of the suspensions (7) is mounted on the hub apparatus (11) which enables the mechanical contact of the wheels (2,3) and the other side is mounted on the vehicle body (8). With the use of the suspension (7), the oscillating movements that will take place in the wheels (2, 3) will provide the changes in the position of the wheels (2, 3) to a certain extent. This positional variability causes the need for the use of the sliding cardan shaft (10) and here the function of the sliding cardan shaft (10) is explained. In the world, these kinds of products have widespread use in different applications. When the ends on the one side of the sliding cardan shaft (10) are coupled to the shafts of the left wheel (2) and the right wheel (3), the ends on the other side of the sliding cardan shaft (10) are coupled to the system so that the rotations of the wheels (2, 3) are controlled.

FIG. 5 is a perspective drawing of the mechanical parts showing the mechanical contact of the front wheel (1) and/or the rear wheel (4) to the vehicle. The mounting of the front-rear wheel mounting support (5), which is generally shown in vertical position in the figures, is mounted in the hole which is in the vertical position on the front-rear wishbone (6). The front-rear wheel mounting support (5), which can freely turn in this hole, allows the front wheel (1) and/or the rear wheel (4) to change direction with respect to the direction of movement of the vehicle. Such direction changing capability of the front wheel (1) and/or the rear wheel (4) is shown in FIG. 5 and it is 360°. The hold of the front wheel (1) and/or rear wheel (4) to the vehicle body (8) on the final point is provided by the front-rear wishbone (6). The mounting of the front-rear wishbone (6) to the vehicle body (8) is carried out by means of the rod, and the front-rear wishbones (6) can turn around this rod. This turning movement allows the oscillating movement of the front-rear wishbones (6) in the vertical position. Here again suspension (7) is used to reduce the vibrations due to road defects. The suspension (7) is mounted to the front-rear wishbone (6) on one side and to the vehicle body (8) on the other side.

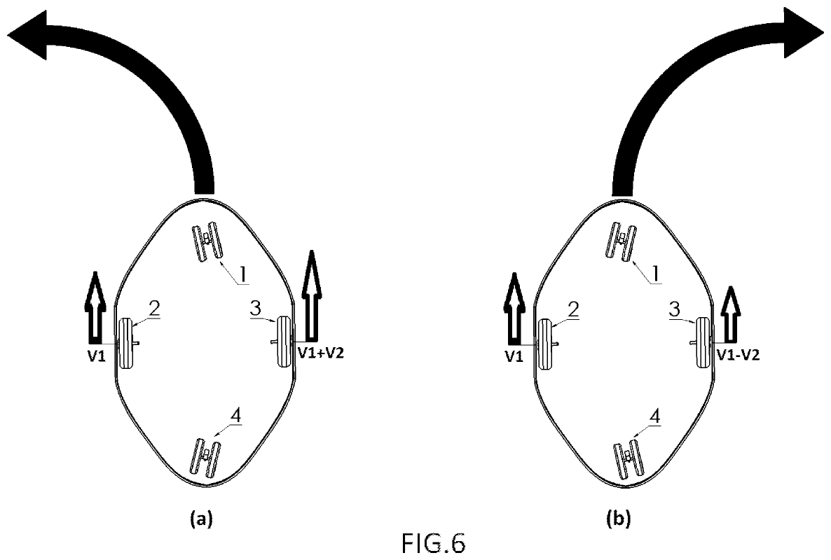

After mentioning the basic elements involved in the vehicle's movement, we can explain the features of the vehicle that go beyond the standard and the system that will provide it. Movement of the vehicle is provided by the rotation of the left wheel (2) and the right wheel (3) as of the logical design of it. The forward and backward movement of the vehicle can be achieved by rotating the right wheel (3) and the left wheel (2), while the speed change provided on the right wheel (3) via Addition reducer (14) provides cornering of the vehicle. This situation is explained in FIG. 6.

While electric motor 1 (13) can provide the power necessary to turn right wheel (3) and left wheel (2) at equal numbers in a unit of time, electric motor 2 (15) can only affect the rotation of right wheel (3). When the vehicle is in motion, the rotation of electric motor 2 (15) at any direction will increase or decrease the rotation speed of right wheel (3). Therefore, the number of cycles in a unit of time will be different between right wheel (3) and left wheel (2). Since the front-rear wheel mounting support (5) can turn in the front-rear wishbone (6) to which it is mounted, the front-rear wheels (1, 4) can take different positions in accordance with the movement positions of other wheels (2, 3). In other words, front-rear wheels (1,4) are not the ones that are affecting the motion of the vehicle, but they are affected from this motion. The difference in the number of cycles in a unit of time between right wheel (3) and left wheel (2) will provide the turning of the vehicle. Front-rear wheels (1,4) will turn in tune with turning direction, so it will not prevent the frictionless turning of the vehicle. FIG. 6 is drawn in parallel with the description in this section and the rotational speed which is generated by the electric motor 1 (13) on the right wheel (3) and the left wheel (2) is expressed as EM1 wheel rpm (V1). Electric motor 2 (15) affects only the rotational speed of the right wheel (3) and this is expressed as EM2 wheel rpm (V2). In FIG. 6a, it is explained visually that when EM1 wheel rpm (V1) and EM2 wheel rpm (V2) are in positive direction (forward), the vehicle will go forward and turn left. In FIG. 6b, it is explained visually that when EM1 wheel rpm (V1) is in positive direction (forward) and EM2 wheel rpm (V2) is in negative direction (backward), the vehicle will go forward and turn right. Also, in the backward motions of the vehicle, cornering and motion suitable with the vectoral relation herein can be performed. After a detailed explanation of the motion logic of the vehicle, we can explain the elements providing this motion.

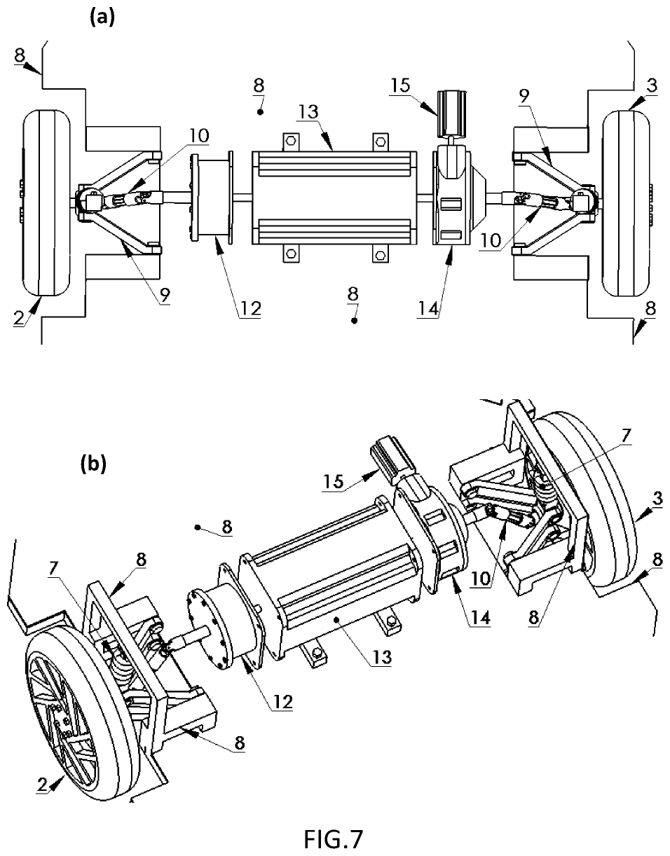

In FIG. 7 the same components are shown in two different perspectives. The components drawn in the FIG. 7 are important to understand the operation mechanism logic of the vehicle. These components will be described in detail. The electric motor 1 (13) has dual opposing shafts, one of which is to feed the left wheel (2) and the other is to feed the right wheel (3). However, in order for the vehicle to perform mentioned motion capabilities, some other intermediary elements are used. The most important one of these is addition reducer (14). Addition reducer (14) adds the rotational movements coming through the shafts of Electric motor 1 (13) and Electric motor 2 (15) in specified rates and transmits it to its output shaft to be transmitted to the right wheel (3). One of two variations is explained in the figures. Addition reducer (14) is mounted to the shaft of the right wheel (3) from the AR output (14c) through AR sliding cardan shaft (10). For this case, primary domain of Addition reducer (14) is the right wheel (3). In another case, Addition reducer (14) can be mounted to the other side of the vehicle and in this way AR output (14c) could be mounted to the shaft of the left wheel (2) through AR sliding cardan shaft (10). In this second case, Addition reducer (14)'s primary domain will be left wheel (2). We have explained these two alternatives here.

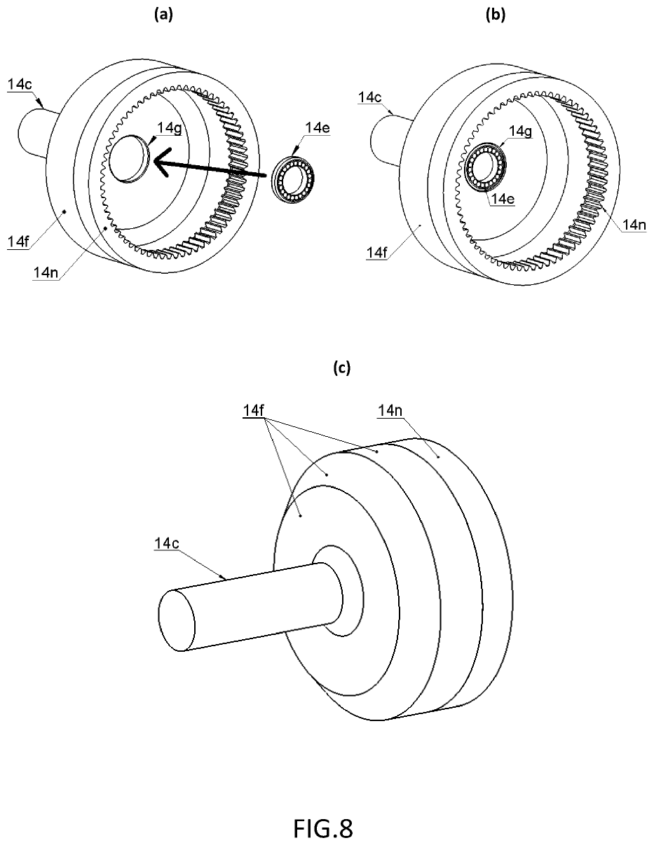

Addition reducer (14) is a special part developed for the invention, and therefore it will be described in detail. It consists of many subparts and sections. The drawings given from FIG. 8 to FIG. 22 describe some subparts of the Addition reducer (14) and as a whole. To describe the task of Addition reducer (14) briefly, it adds up the rotation speeds of AR input 1 (14a) and AR input 2 (14b) at certain ratios, and transmits this to AR output (14c). The certain ratios depend on the gear ratios used in the content of Addition reducer (14). What aimed here for the mentioned section is that it includes the gear box feature at the same time. For this purpose, the gear ratio from AR input 1 (14a) to AR output (14c) satisfies a determined value. Briefly, while the rotation power is transferred from electric motor 1 (13) to the right wheel (3) via Addition reducer (14), at the same time, the rotation speed decreases and the torque value increases. The speed reducer (12) will do the same process for the left wheel (2). Thus, the left wheel (2) and the right wheel (3) can be rotated at equal speed and with high torque by the Electric motor 1 (13).

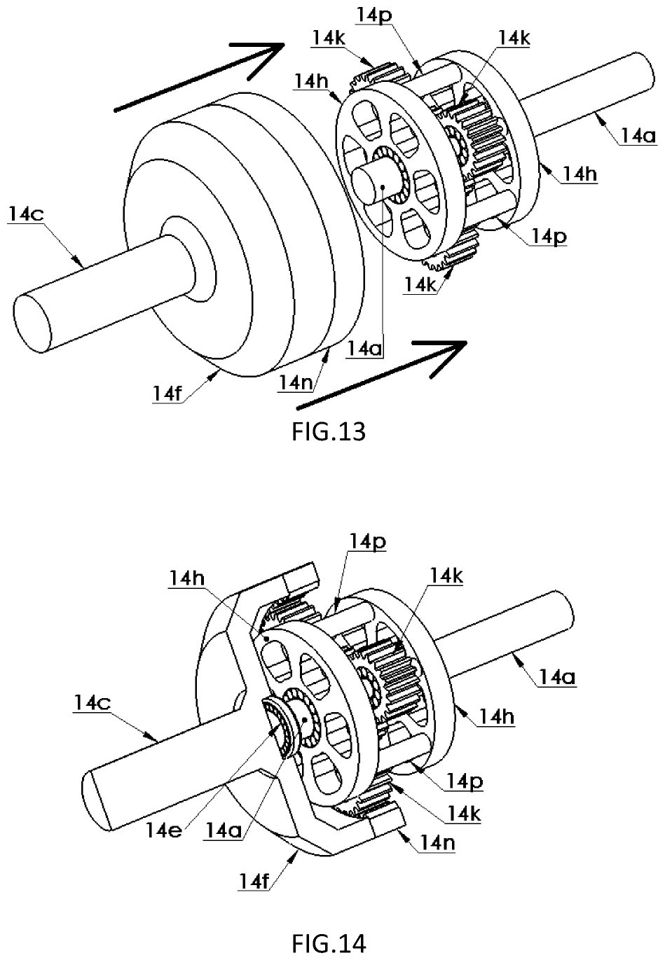

Let's explain the subparts that will enable Addition reducer (14) to accomplish its task. FIG. 8 is three separate drawings showing the assembly details of the parts fixed on AR cylinder (14f). In FIG. 8c showing the outer part of the AR cylinder (14f), the AR cylinder (14f) is shown coupled with the AR output (14c) rod. The mounting of AR output (14c) to AR cylinder (14f) is fixed firmly in order to bear high force values applied from outside. There is an AR bearing hole (14g) in the middle of the inside of the AR cylinder (14f), which is illustrated in FIG. 8a. The AR bearing (14e) will be mounted to this section as indicated by the arrow mark in FIG. 8a. In FIG. 8b we can see that the AR bearing (14e) is fixed to this section. As can be seen from FIG. 14, this AR bearing (14e) is intended for mounting of AR input 1 (14a) into AR bearing hole (14g), which allows it (14e) to rotate with less friction and without disruption of this section (14g). Another detail shown in FIG. 8a and FIG. 8b is that AR ring gear (14n) is fixed on AR cylinder (14f). The reason why this section (14n) is threaded is to mechanically interact with AR planet gears (14k). From this point, FIG. 13 and FIG. 14, which explains the configuration of AR cylinder (14f) and its fixed mounting parts with the system, can be analyzed. The AR cylinder (14f) is integrated with the parts shown by the movement in the arrow direction on FIG. 13.

AR bearing (14e) has a bearing cone through which the shafts are passed and mounted and these shaft can rotate with minimum friction in this cone. AR bearing (14e) is fixed to the related section in order to protect the positions of the shaft.

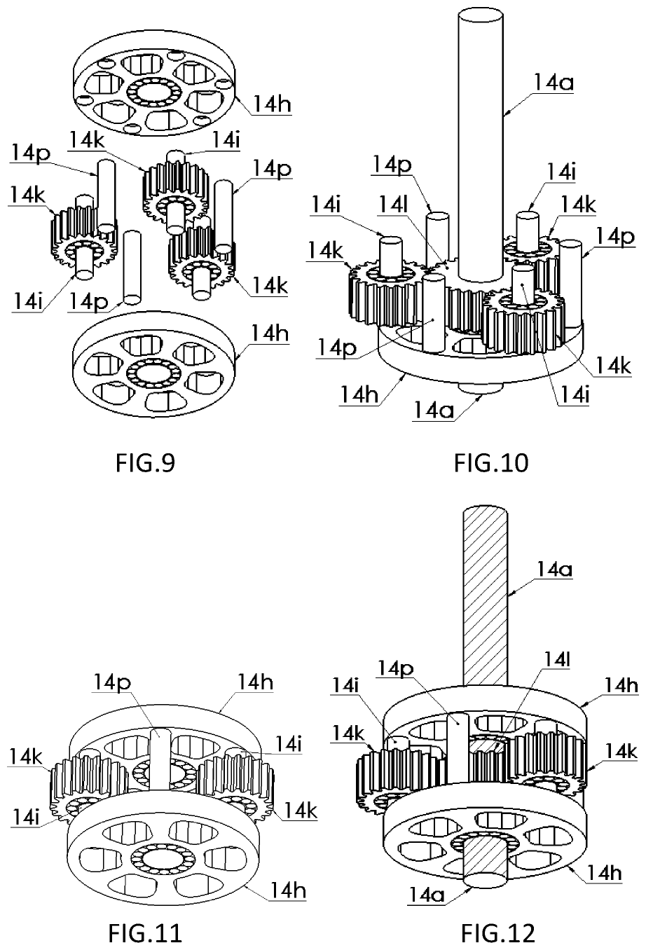

In FIG. 9, mounting parts of AR planet carrier (14h) are shown. Here, some parts (14h,14i,14p) are shown separately in an unmounted position. In order to describe the parts used in detail, the explanations are sometimes made over separated and unmounted views. AR sungear (14l) drawn in FIG. 10 and FIG. 12 is fixed to AR input 1 (14a) from its (14l) center. As it can be understood from the drawings, the circular and outer part of the AR sun gear (14l) has a threaded form compatible with AR planet gears (14k). The rotation of AR sun gear (14l) is fully dependent on AR input 1 (14a) shaft.

When the drawings from FIG. 9 to FIG. 12 are examined, the AR planet gears (14k), AR planet carrier (14h), AR support rod (14p) and AR planet carrier rod (14i) are drawn from their dismounted state to the mounted state. AR planet gears (14k) are mounted on AR planet carrier rod (14i). The important detail is that owing to the bearing cone structure of AR planet gears (14k) around the mounting side, it can rotate without friction around AR planet carrier rod (14i) and independently from this rod (14i). This rotation is an important detail in transferring the rotary kinetic energy coming from AR input 1 (14a) shaft and AR input 2 (14b) shaft to AR ring gear (14n). As it is shown in the figures, AR planet gears (14k) are circular parts with threaded outer side that is compatible with AR ring gear (14n) and AR sun gear (14l).

FIG. 12 shows AR planet carrier (14h) mounted with its related parts. AR planet carrier (14h) is a circular structure and it (14h) is mounted on AR input 1 (14a) shaft from the center. Owing to the bearing cone structure of AR planet carrier (14h) around the mounting side, it can rotate around AR input 1 (14a) shaft and independently form this shaft (14a). AR planet carrier (14h) is not a threaded structure.

AR planet carrier rods (14i) are the parts that are mounted between two AR planet carriers (14h). AR planet carrier rods (14i) function as mounting parts of AR planet gears (14k). A perspective drawing of AR planet carrier rod (14i), AR planet carrier (14h), AR support rod (14p) and AR planet gears (14k) are shown as isolated from other parts in FIG. 9 and FIG. 11 so as to show their mounting relations in detail. There are three AR planet carrier rods (14i) and three AR planet gears (14k) shown in figures. This number can be increased or decreased optionally and depending on the value of the force applied on these points. They should be existing above certain numbers for the continuity of mechanical endurance.

AR support rod (14p) is used to reinforce two AR planetary carriers (14h) as one piece. It was used to increase mechanical durability. It (14p) can be considered as an optional element. Though it is not compulsory to be used, it is useful.

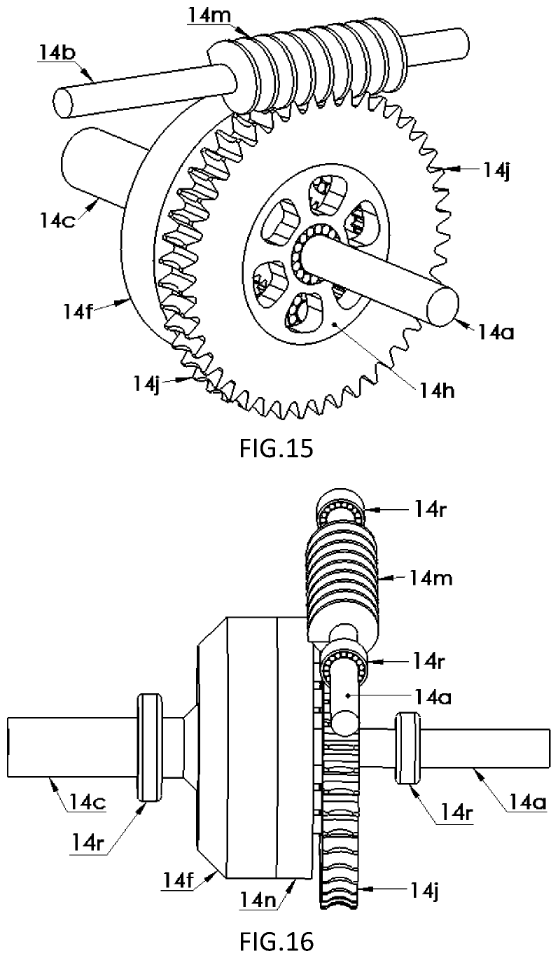

Mounted position of AR worm wheel (14j) can be seen in FIG. 15. AR worm wheel (14j) is a circular structure and it (14j) is fixed on AR planet carrier (14h). As it is shown in the figures, outer side of AR worm wheel (14j) has a threaded part compatible with AR worm gear (14m). With the rotational movement AR worm wheel (14j) receives from AR input 2 (14b) via AR worm gear (14m), AR worm wheel (14j) will rotate AR planet carrier (14h).

AR worm gear (14m), explained in FIG. 15 and FIG. 16, is the gear fixed on AR input 2 (14b). It (14m) takes place in transferring the rotary kinetic energy on AR input 2 (14b) shaft to AR worm wheel (14j). The reason of worm gear interaction between AR worm gear (14m) and AR worm wheel (14j) is to create a one-way kinetic energy. While transferring the kinetic energy to AR worm wheel (14j) from to AR input 2 (14b), the aim is to block kinetic energy that can be transferred from AR worm wheel (14j) to AR input 2 (14b). Moreover, the aim is to generate high gear rates in this section, and in this way torque value on AR input 2 (14b) is multiplied while being transferred to AR worm wheel (14j). Because AR input 2 (14b) shaft is only used in turning the vehicle, electric motor 2 (15), which is fixed to AR input 2 (14b) shaft, does not have to have high power values according to the other electric motor 1 (13). For cornering movements of the vehicle, it is enough to generate low speed and enough torque values. In fact, reaching high speeds for cornering of the vehicle will cause uncontrollability and dangerous situation. When these are considered, gear ratio between AR worm gear (14m) and AR worm wheel (14j) must be higher than 3:1. If we take this ratio as 50:1 roughly for more ideal values, this would give us a view to understand the effectiveness of the system. In this way, electric motor 2 (15) would have less power compared to electric motor 1 (13). This situation will provide the slow but high-torque rotation necessary by the electric motor 2 (15) with much lower power, and the losses in the worm gear assembly would be at unimportant levels compared to total system power. Another detail we can see at FIG. 16 is AR body bearing (14r) supporting the mounting of shafts on AR body (14d). Bearings are standardized machine equipment. AR body bearing (14r) is standardized bearing.

It is important to understand what kind of interactions the subparts of Addition reducer (14) have with each other in order to comprehend its (14) working logic. Therefore, the tasks and working ways of the parts shown with the drawings from FIG. 8 to FIG. 16 will be explained. The explanation will be made by going from the part to whole from FIG. 8 through FIG. 16.

AR cylinder (14f), drawn in FIG. 8, transfers the rotary kinetic energy which it receives from AR ring gear (14n) to AR output (14c) shaft. Therefore, AR output (14c) is fixed to the center of circular shaped outer side of AR cylinder (14f) shown in FIG. 8c.

AR sun gear (14l) is fixed on AR input 1 (14a) so as not to slide and has fully dependent rotary motion on AR input 1 (14a), and it (14l) transfers the rotary kinetic energy on AR input 1 (14a) to AR planet gears (14k). Owing to the fact that AR planet gears (14k) can rotate around AR planet carrier rod (14i), it can transfer the rotary kinetic energy which it receives from AR sun gear (14l) to AR ring gear (14n) in the same way. For the transfer of the rotary kinetic energy mentioned here, the threaded side of AR planet gears (14k) is in mechanical contact and compatible with the threaded side of AR sun gear (14l) and the threaded side in AR ring gear (14n).

The position of AR planet carrier rod (14i) and AR planet carrier (14h) to which AR planet gears (14k), which has a critical role in the transfer of kinetic energy, are mounted is also very important. The motion of AR planet carrier (14h) is fully dependent on AR worm wheel (14j). The purpose here is that AR worm wheel (14j) is rotated as a set with the AR planet carrier (14h) to which it is mounted, independently from the AR input 1 (14a)'s rotation, and showing the same rotation movement with AR planet carrier rod (14i). Also, AR planet carrier rod (14i) rotates in the same direction with AR planet carrier (14h) but makes different number of cycles in proportion to its own diameter and the diameter of AR sun gear (14l) by considering contact relation with AR sun gear (14l). In this case, while AR planet gears (14k) rotates around AR planet carrier rod (14i), their (14k) angular rotation around AR input 1 (14a) changes. In other words, there are two different types of motion.

In FIG. 14, drawing is made in a way that AR output (14c), AR cylinder (14f) and AR ring gear (14n) are cut open in half. Such drawing is made to show especially the parts mounted in AR cylinder (14f). When the drawing is viewed carefully, one end of AR input 1 (14a) is fitted and mounted inside AR cylinder bearing hole (14g) through AR bearing (14e). Transmission of rotation force of AR input 1 (14a) to AR cylinder (14f) in this section via AR bearing (14e) is prevented. This mounting point helps to keep the positions of AR input 1 (14a) and the components mounted on AR input 1 (14a) stable. Continuing with FIG. 14, AR planet carrier (14h) does not have any contact with AR cylinder (14f). AR planet gears (14k) are in mechanical contact with AR ring gear (14n). This mechanical contact relation is the one that rotates AR cylinder (14f) and accordingly AR output (14c). Another way to provide the rotation of AR output (14c) is to rotate AR planet carrier (14h). For this, AR worm wheel (14j) is fixed on AR planet carrier (14h) as shown in FIG. 15. In this way, rotation of AR worm wheel (14j) will rotate AR planet carrier (14h). In FIG. 15 also, AR worm gear (14m) whose threaded parts are in mechanical contact with AR worm wheel (14j) is shown. AR worm gear (14m) is fixed on AR input 2 (14b), and thus, it makes a fully dependent rotation with AR input 2 (14b). AR worm gear (14m) takes place in transferring the rotary kinetic energy on AR input 2 (14b) over to AR worm wheel (14j). As it is mentioned before, worm gear here is used in order to provide a one-way kinetic energy flow. In FIG. 16, AR bearings (14e) which are located on AR input 1 (14a), AR input 2 (14b), AR output (14c) and acting as intermediary for these rods (14a, 14b, 14c) to be mounted on AR body (14d) are shown. In FIG. 16, there is a rough drawing to show how these mountings are positioned. In FIG. 23, fully assembled state of Addition reducer (14) is shown.

To go over the working logic of the system roughly; when AR input 1 (14a) rotates, AR sun gear (14l) will also rotate and accordingly, AR planet gears (14k) will also rotate. The rotation of AR planet gears (14k) will also rotate AR cylinder (14f) due to mechanical contact relation of AR planet gears (14k) with AR ring gear (14n). On the other hand, AR output (14c), which is the extension of outer side of AR cylinder (14f), will rotate exactly the same with the rotation of AR cylinder (14f). When these motions are being carried out, rotating the AR input 2 (14b) will affect the rotation of AR output (14c). When AR input 2 (14b) rotates, AR worm gear (14m) will also rotate, and accordingly, AR worm wheel (14j) will also rotate. The rotation of AR worm wheel (14j) will lead to the rotation of all parts shown in FIG. 11 in the same direction and same angle around AR input 1 (14a). Rotating AR planet carrier rods (14i) around AR input 1 (14a) will also carry AR planet gears (14k). A detail here is that AR planet gears (14k) will also rotate around its own axis (14i) due to the contact relation with AR sun gear (14l). These both types of rotation will be transferred to AR cylinder (14f) and cause its (14f) rotation because of the mechanical contact relation between AR planet gears (14k) and AR ring gear (14n). The rotation of AR cylinder (14f) means the rotation of AR output (14c). Finally, both the rotation effect of AR input 1 (14a) and the rotation effect of AR input 2 (14b) are reflected to AR output (14c).

In general, in this system, by applying high power (high speed, normal torque) input through AR input 1 (14a), this power is transferred to AR output (14c) by decreasing speed and increasing torque according to gear ratios. The reason is that electric motors in electric cars are used with gear box. Addition reducer (14) also acts as gear box at the same time. Although the rotation speed of AR speed (14c) decreases in compared to AR input 1 (14a), it will be sufficient for vehicle speed. AR output (14c) can be rotated at high speeds and high torques. This is an important parameter for the vehicle's speed. Low power (high speed, low torque) is applied through AR input 2 (14b) and this causes a low level speed change with a high torque on AR output (14c). Since this would provide vehicle's turning, there is no need for high speed changes.

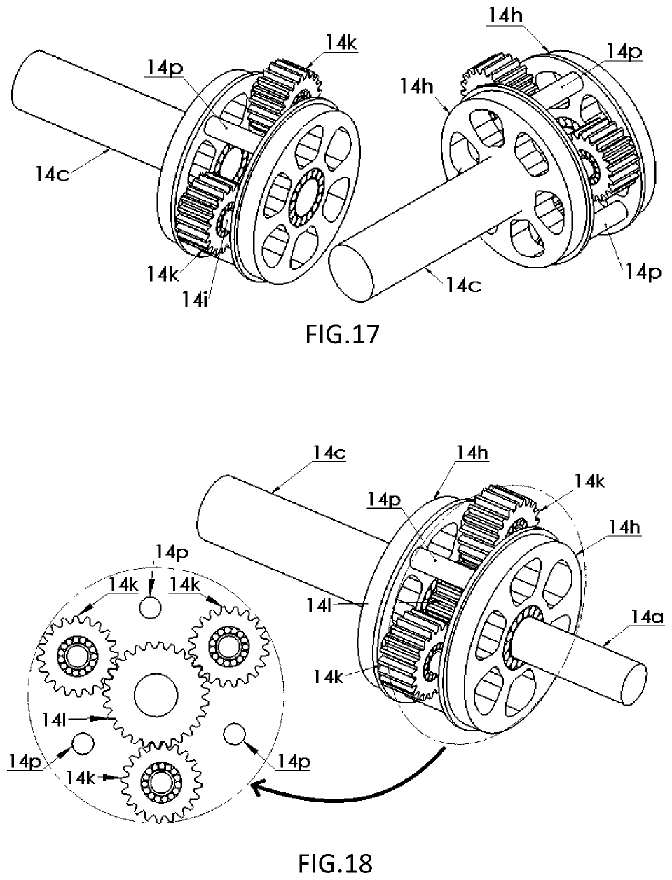

We have explained how the mechanism inside Addition reducer (14) works. In this method, while AR sun gear (14l) and AR planet carrier (14h) are the active parts in input, AR ring gear (14n) is the active part of the output. By using another method, a system to serve the same purpose as Addition reducer (14) can be developed. This time, while AR sun gear (14l) and AR ring gear (14n) are used as active parts of the inputs, AR planet carrier (14h) would be the active part of the output. This alternative version of addition reducer (14) is explained by drawings from FIG. 17 to FIG. 22.

As AR planet carrier (14h) will be used as output in the alternative version, AR output (14c) and AR planet carrier (14h) are fixed to each other. In the same way with the previous system, AR planet gears (14k) are mounted to AR planet carrier (14h) with the help of AR planet carrier rod (14i). Bearing cone of the AR planet gears (14k) provides an ease for the rotation of it (14k) around AR planet carrier rod (14i). These details are shown in FIG. 17.

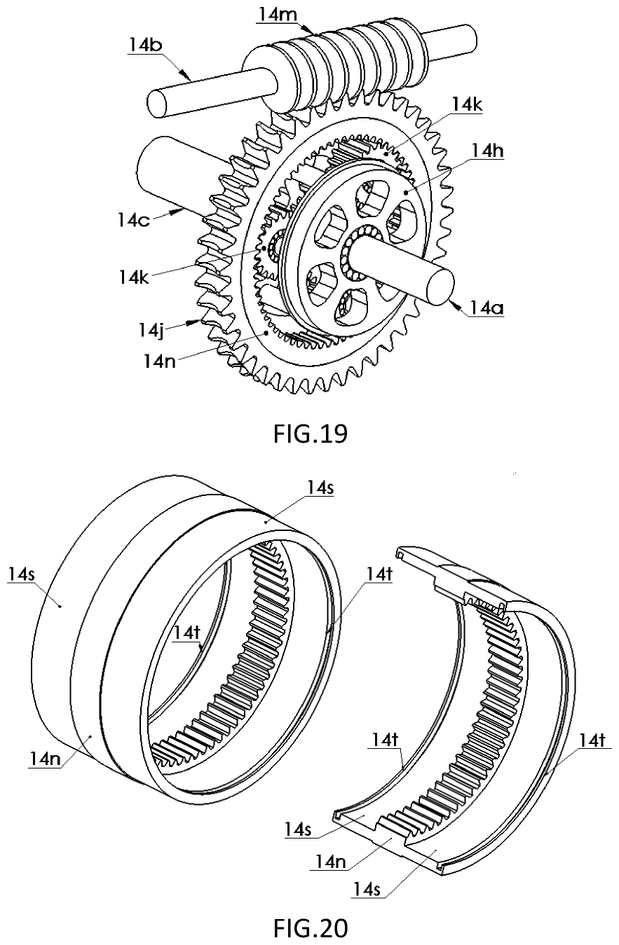

Same as before, AR sun gear (14l) is fixed on AR input 1 (14a). Therefore, the rotation of AR sun gear (14l) is fully dependent on AR input 1 (14a). This component (14a, 14l), is mounted in a way so that it provides a threaded contact between AR sun gear (14l) and AR planet gears (14k) as shown in FIG. 18. There is a bearing cone in the center of AR planet carrier. This cone provides AR planet carrier (14h) with an independent rotation from AR input 1 (14a). On these parts (shown in FIG. 18), AR ring gear (14n), AR worm wheel (14j), AR worm gear (14m) and AR input 2 (14b) are mounted as shown in FIG. 19. AR ring gear (14n) and AR worm wheel (14j) are fixed to each other and they act as a single unit. AR ring gear (14n) is mounted around AR planet gears (14k). The rotation of AR ring gear (14n) will rotate AR planet gears (14k). AR worm gear (14m) is fixed to the shaft of AR input 2 (14b). AR worm gear (14m) and AR worm wheel (14j) are in mechanical contact with each other by worm gear assembly.

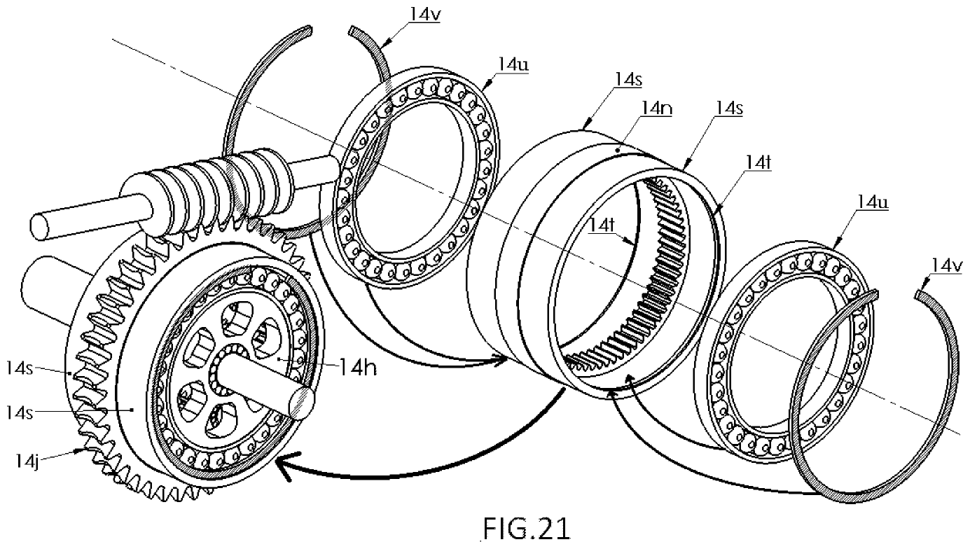

The rotation of the AR worm gear (14m) will rotate the AR worm wheel (14j) and the AR ring gear (14n) around the AR input 1 (14a) (radial). However, due to frictions in the worm gear set (14m, 14j), forces (axial) in the direction of AR input 1 (14a) will also occur. This will force the AR worm wheel (14j) and the AR ring gear (14n) set to axial movement. Thus, the AR worm wheel (14j), which should be under AR worm gear (14m), will shift sideways. We will describe the technique developed in order to maintain the working position of AR worm wheel (14j) and AR ring gear (14n) as a set to prevent this negative situation in FIG. 20 and FIG. 21.

Two ring-shaped pieces of AR ring gear support (14s) are attached to the sides of the AR ring gear (14n), which can be seen in FIG. 20. In terms of mechanical durability, AR ring gear support (14s) is produced as one piece integrated with AR ring gear (14n). To better illustrate this, a cross-sectional view is also shown in FIG. 20.

AR support bearing (14u) is standardized bearing in industrial applications. It is used to reduce friction when assembling the rotating object. The AR circlip (14v) is a support-mounting element that prevents such bearings from sliding in the mounting zone.

What is described in FIG. 21 is that the AR support bearing (14u) will be inserted into inner side of the AR ring gear support (14s). While AR support bearing (14u) touches the AR ring gear support (14s) on the outside, it (14u) touches AR planet carrier (14h) on the inside. Furthermore, to prevent axial movement (to prevent sliding), the AR support bearing (14u) rests against the rim of the AR planetary carrier (14h) on the one side and rests on the AR circlip (14v) on the other side. In this section, the AR support bearing (14u), which is encircled from all sides, will maintain working position of AR worm wheel (14j) and AR ring gear (14n) as a set. We can see the rim of AR planet carrier (14h) in FIG. 17, FIG. 18, and FIG. 19. The AR circlip (14v) is a standardized bearing ring and requires a groove for its installation. For this purpose, a groove defined as AR circlip channel (14t) is formed near the edge of the inner side of the AR ring gear support (14s). AR circlip (14v) will be placed-fitted into this groove. Although, the AR support bearing (14u) and its associated elements (14t, 14v, 14s) are expressed as dual pieces in the drawings, they can be used as single but such use will reduce mechanical strength.

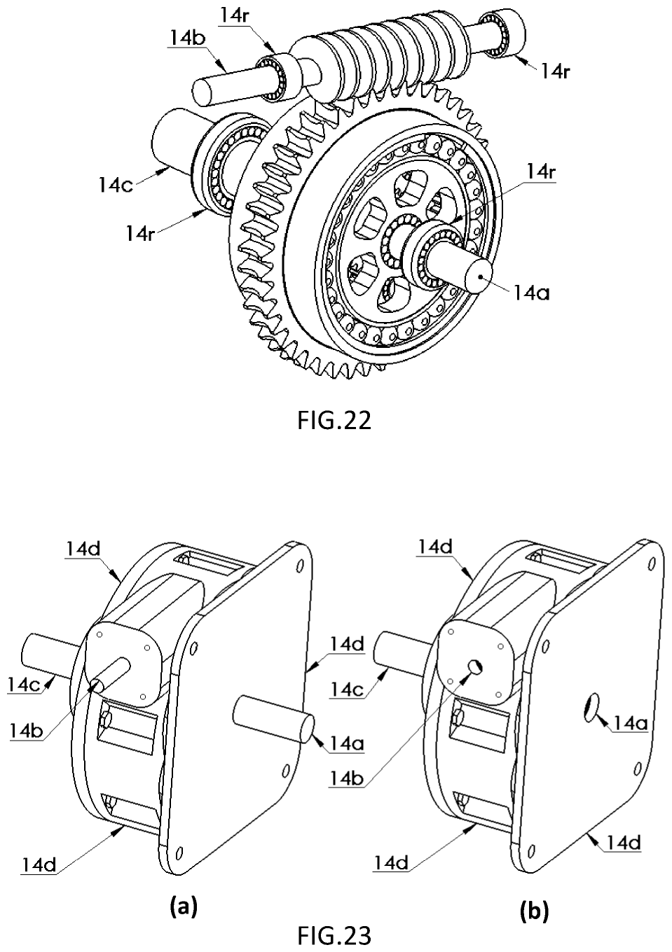

In FIG. 22, AR body bearings (14r) that are used in the mounting of the alternative version Addition reducer (14) mechanism on the body (14d) are shown. AR body bearing (14r) reduce frictions in the places where shafts are mounted due to their bearing cone structure.

The working logic of the alternative version for Addition reducer (14) is as follows. The rotation motion coming from AR input 1 (14a) is transferred to AR planet gears (14k) through AR sun gear (14l). This causes the rotation of AR planet gears (14k). In this way, AR planet gears (14k) are moved on AR ring gear (14n) and they (14k) follow an orbital path around AR sun gear (14l). AR planet carrier (14h) also shows an orbital rotation together with AR planet gears (14k). As AR output (14c) is fixed to AR planet carrier (14h), AR output (14c) will rotate. The rotation motion transferred from AR input 1 (14a) reaches to AR output (14c) in this way. It is also a need to have a determined gear ratio from AR input 1 (14a) to AR output (14c) similar to the gear box in electric vehicles. The torque of the electric motor 1 (13) is increased by this gear ratio scale. This gear ratio value is not as high as in the worm gear set (14m, 14j).

The rotation motion of AR input 2 (14b) is transferred to AR worm wheel (14j) through AR worm gear (14m). The worm gear contact is because of the need to transfer the motion in one direction. AR worm wheel (14j) rotates together with AR ring gear (14n). The gear contact between AR ring gear (14n) and AR planet gears (14k) will rotate the AR planet gears (14k). In this way, with the rotation of AR planet gears (14k), they (14k) follow an orbital path around AR sun gear (14l). AR planet carrier (14h) also shows an orbital rotation together with AR planet gears (14k). As AR output (14c) is fixed to AR planet carrier (14h), AR output (14c) will also rotate. The rotation motion transferred from AR input 2 (14b) reaches to AR output (14c) in this way. AR input 1 (14a) and AR input 2 (14b) affect AR output (14c) from different ways. As a result, AR input 1 (14a) and AR input 2 (14b) will have an independent effect on the speed of AR output (14c). As AR input 2 (14b) is used in the direction control of the vehicle, the gear ratio between AR worm gear (14m) and AR worm wheel (14j) needs to be bigger than 3:1. This ratio must be a lot higher in order for electric motor 2 (15) to be small enough. The speed change provided by AR input 2 (14b) on AR output (14c) does not need to be at high levels because this speed change is used in the direction control of the vehicle. However, the speed provided by AR input 1 (14a) on AR output (14c) must be able to reach high levels because this speed provides forward-backward motion of the vehicle.

The structure, which acts as a body for the mechanism in Addition reducer (14), keeps the system stabilized in itself, and protects the system. The mechanism in Addition reducer (14) is held by AR body bearing (14r) shown in FIG. 16 or FIG. 22. Geometrical shapes of AR body (14d) is shown by the drawings in FIG. 23, and they do not have to be in a standard shape. AR body (14d) can be formed in different shapes to hold the mechanism in the Addition reducer (14) in specified positions via bearings (14r) shown in FIG. 16 or FIG. 22. At the same time, AR body (14d) provides a better working environment for the gears and bearings with the oil kept inside. For the rotating shaft (14a, 14b, 14c) positions, using oil seal ring assists in the oil sealing. Oil seal ring is a commonly used product in machinery applications.

In FIG. 23 there are two different version drawings, a and b. In FIG. 23a, the AR input 1 (14a) and AR input 2 (14b) shafts have a male-type mechanical connection point. In FIG. 23b, the AR input 1 (14a) and AR input 2 (14b) shafts have female-type mechanical connection point. For a more compact installation, the appropriate version can be used. This is a detail used only in mechanical connection of Electric motor 1 (13). There is no functional change in the content of Addition reducer (14) or alternative version of Addition reducer (14).

Speed reducer's (12) task in the system is to reduce the rotation speed of the electric motor 1 (13) shaft before transmitting it to the left wheel (2). The reason why this reducer (12) is used is because of the fact that the shaft rotary speed of the rotary motion energy transmitted from the electric motor 1 (13) to right wheel (3) reduces while it is being transferred from AR input 1 (14a) to AR output (14c). The direction of rotation varies for the first version addition reducer (14), while it does not change for the alternative version (second) addition reducer (14). The same speed and direction change need to be provided while transferring it from the electric motor 1 (13) shaft to the left wheel (2). In this way, the right wheel (3) and the left wheel (2) can rotate at the same speed and direction with the turning force provided by the electric motor 1 (13). Such products (12) are standardized reducers (gear box) available in the market-industry in abundant quantities with various gear ratios in different models and shapes.

The mechanical interactions of the components in FIG. 7 will be explained. The speed reducer (12), electric motor 1 (13), Addition reducer (14) and electric motor 2 (15) are fixed to the vehicle body (8). When FIG. 7 is examined, the one shaft of electric motor 1 (13) is mounted to the shaft of AR input 1 (14a). The other shaft of the electric motor 1 (13) is mounted to the input part of speed reducer (12). The output part of speed reducer (12) is mechanically attached to the left wheel (2) through sliding cardan shaft (10). The right wheel (3), on the other hand, is mechanically attached to Addition reducer (14) from AR output (14c) section via sliding cardan shaft (10). The wheels (2, 3) will be rotated through sliding cardan shafts (10). Electric motor 2 (15)'s shaft is mounted to the AR input 2 (14b). Having explained the mechanical interactions of the components in FIG. 7, let's analyse their functions as a whole. The rotary motion energy provided by the electric motor 1 (13) is transferred to Addition reducer (14) and speed reducer (12). The rotation speeds of AR input 1 (14a) and AR input 2 (14b) are added up at specified rates and transmitted to AR output (14c). Transferring the rotary motion energy on AR output (14c) to the right wheel (3) is carried out by means of sliding cardan shaft (10). The reason why the speed reducer (12) is used is because of Addition reducer (14). The fact is that the rotation speed of AR 1 (14a) is not transferred to AR output (14c) in the same speed. This speed is transferred at a specified rate. AR output (14c) shaft rotates the right wheel (3). The right wheel (3) and the left wheel (2) should be rotated in the same speed and same direction with the rotational force applied from the electric motor 1 (13). Therefore, the speed reducer (12) which has the same gear ratio and same rotational direction change (There is no direction change in alternative version addition reducer (14)) as in between AR input 1 (14a) and AR output (14c) is used.

Therefore, right wheel (3) and the left wheel (2) will rotate in the same speed and same direction with the rotational force applied by the electric motor 1 (13). This situation is defined as EM1 wheel rpm (V1). The rotary motion energy transferred to AR input 2 (14b) from the electric motor 2 (15) will cause a speed change on the AR output (14c) due to the working logic of Addition reducer (14). This situation is defined as EM2 wheel rpm (V2). This speed change will provide the vehicle to be turned at the aimed direction. FIG. 6 is drawn to explain these situations.

If AR input 1 (14a) does not rotate, the rotation motion by this shaft (14a) will not be reflected onto AR output (14c). Therefore, when the electric motor 2 (15) shaft rotates, this rotation will reflect to AR output (14c) at a certain rate. When the left wheel (2) is not rotating, the right wheel (3) will rotate. The need to turn the vehicle without any forward-backward movement will be met; however, this turn will require more cornering distance because the vehicle will turn around the left wheel (2). In this case, rotating the left wheel (2) in the opposite direction by using electric motor 1 (13) will reduce the cornering distance needed and the cornering point will move to the middle of the distance between the right wheel (3) and the left wheel (2) of the vehicle. That means that the vehicle will turn around its own axis on the point of presence. In order to perform such turn, what ever the rotation speed value applied by the electric motor 2 (15) to the right wheel (3) is, the half value of this speed will be applied by the electric motor 1 (13) in the opposite direction. In this way, the rotation speed value of the right wheel (3) will be reduced by half by the rotation motion transmitted from AR input 1 (14a). The speed of the left wheel (2), however, will be the same with the speed of right wheel (3) but in the opposite direction. As a result, the vehicle will be able to turn without making forwards-backwards motions. Vehicle can rotate around itself.

The template shown in FIG. 22 will explain the basic management activity of the vehicle. The lines drawn in this template represent the electrical and electronic interaction between the elements. Control unit (16) is the component that electrically and electronically gets in contact with all the components operating in the electrical and electronical environment and carries out all the coordination and management activities. The control unit (16) has the electronic software which is prepared suitable to the system to carry out determined logical operations. Control of the vehicle by the driver will be carried out electronically on the system. The driver can be real person or software (autonomous driving). The electronic data representing the vehicle control of the driver is defined as the driving control data (17). Control unit (16) controls the motion of the vehicle by using electric motor 1 (13) and electric motor 2 (15) in accordance with driving control data (17). The speed of the electric motor 1 (13) will be adjusted according to the data related to the speed of the vehicle sent by the driver and the speed of the electric motor 2 (15) will be set according to the data related to the cornering of the vehicle transmitted by the driver.

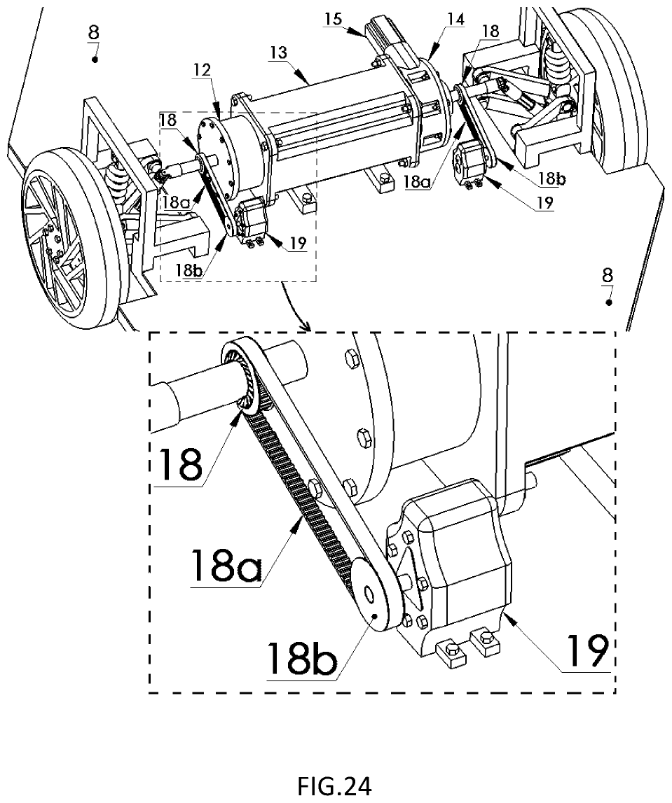

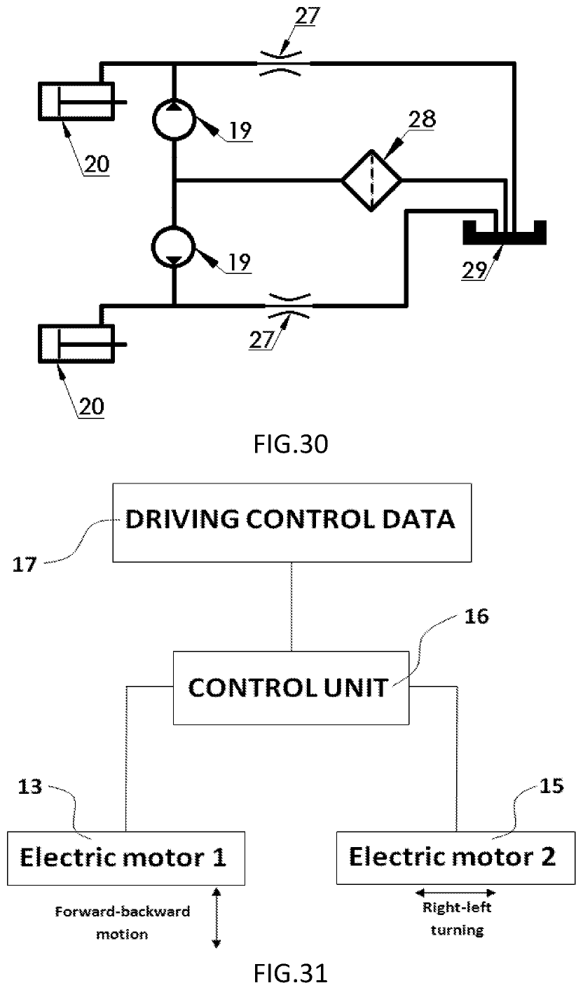

The vehicle will be able to perform the desired movements with the operation of the systems described up to this section. However, providing direction control based on the rotational speed between only the side wheels (2,3) of the vehicle will only yield good results at low speeds. As you reach high speeds, vehicle's gripping on the road and handling will weaken, especially on defective roads. Hydraulic system has been added to ensure good directional control of such vehicles at also high speeds. The hydraulic system enables the vehicle to be steered on the front and/or rear wheels (1,4) according to the travel direction. As the speed of the vehicle increases, the effect of the hydraulic system increases. This eliminates the negativity during direction control of the vehicle at high speeds. Between FIG. 24 and FIG. 30, this hydraulic system will be described.

FIG. 24 is the assembly for rotating the rod of the hydraulic pump (19). The two hydraulic pumps (19) receive their power over the shafts which rotate the left and right wheels (2,3). For this purpose, the belt pulley with one-way bearing (18) is mounted on the shaft. As the vehicle moves forward, belt pulley with one-way bearing (18) locks itself and rotates the belt pulley (18b) by moving the belt (18a). When the vehicle is moving backwards, the belt pulley with one-way bearing (18) opens itself and does not move the belt (18a) and therefore does not rotate the belt pulley (18b). The one-way bearing is mounted to the center of the belt pulley (18b) and the belt pulley with one-way bearing (18) is obtained. That is, the Belt pulley (18b) is turned into a belt pulley with one-way bearing (18). In the drawing, the belt pulley with one-way bearing (18) is on the shaft which rotates the side wheels (2, 3), while there is Belt pulley (18b) on rod of the hydraulic pump (19). It could be the exact opposite. That is, there can be Belt pulley (18b) on the shaft that rotates the side wheels (2,3), while the belt pulley with one-way bearing (18) can be on the rod of the hydraulic pump (19). The system will operate with the same logic.

The functional difference that will be generated on the rod of the hydraulic pump (19) during forward and backward rotations of the side wheel (2,3) shafts is provided by one-way bearing. One-way bearing is widely used in machinery applications. The rotation of the belt pulley (18b) is prevented while the vehicle is traveling in the backward direction. This is because the hydraulic system is deactivated as the vehicle will not reach high speed when driving in the backward direction. At low speeds there is no need for direction control of the front-rear wheels (1, 4).

By the method described above, the belt pulley (18b) will rotate while the vehicle is moving in the forward direction. The rotation of the belt pulley (18b) will cause the hydraulic pump (19) to pump hydraulic oil. The important point here is that the amount of oil pumped by the hydraulic pump (19) per unit time depends on the rotational speed of the belt pulley (18b). The speed of the belt pulley (18b) is directly proportional to the vehicle speed as it (18b) is rotated by the shafts that rotate the side wheels (2,3) of the vehicle. Briefly, the amount of oil pumped by the hydraulic pumps (19) per unit time is directly proportional to the vehicle speed. Another important point is that the quantities of oil that the two hydraulic pumps (19) pump per unit time are equal when the shafts rotating the side wheels (2,3) of the vehicle rotate at equal speeds (the vehicle is traveling straight). This is necessary in order to generate equal pressure and equal amounts of tensile force in the hydraulic cylinders (20), which will be discussed later.

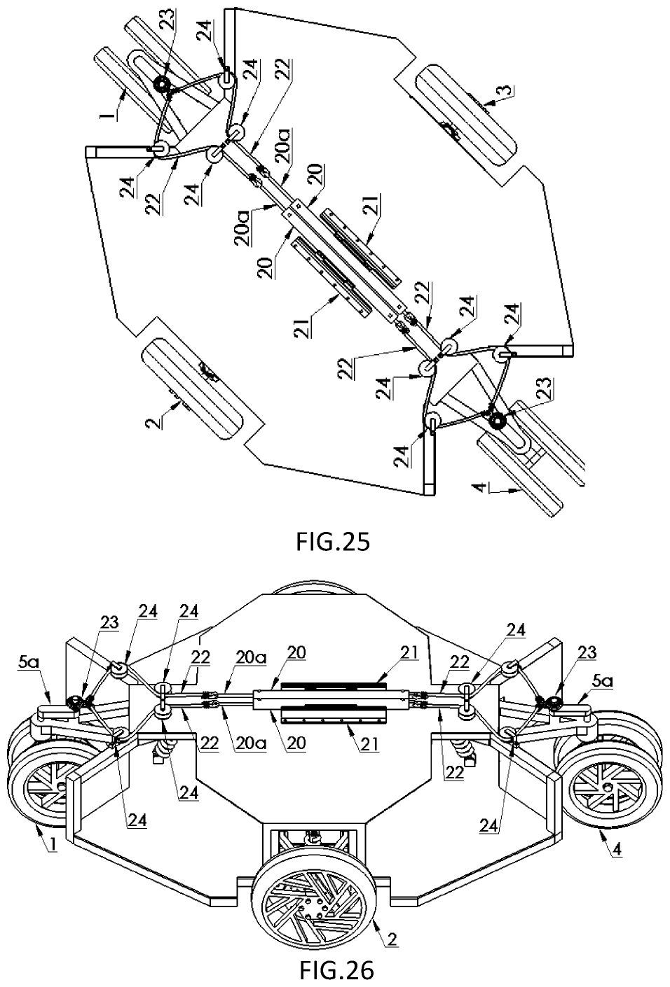

The left-side hydraulic pump (19) in FIG. 24 feeds the hydraulic cylinder (20) that is on the left in FIG. 25 and FIG. 26. The right-side hydraulic pump (19) in FIG. 24 feeds the hydraulic cylinder (20) that is on the right in FIG. 25 and FIG. 26. And the hydraulic pumps (19) affect in the direction of closing of the hydraulic cylinders 20. For the hydraulic system to function correctly, two hydraulic pumps (19) must have the same displacement value and two hydraulic cylinders (20) and their parts must have the same physical dimensions and structure.

FIGS. 25 and 26 show the parts used for transmitting the linear force to be generated in the hydraulic cylinders (20) to the front-rear wheel steering handle (5a). Hydraulic cylinders (20) are mounted to the vehicle body (8) by means of linear rails (21). The linear rail (21) has a carriage moving linearly on the rail. The elements mounted on this carriage move linearly at a level where friction is minimized. Similar applications have widespread use in the industry. In this application, the hydraulic cylinders (20) are mounted on the carriage of the linear rail (21). Thus, the forward and backward movement of the hydraulic cylinders (20) in the direction of the linear rail (21) will be without problem. This detail is important in the opening and closing of the hydraulic piston rod (20a).

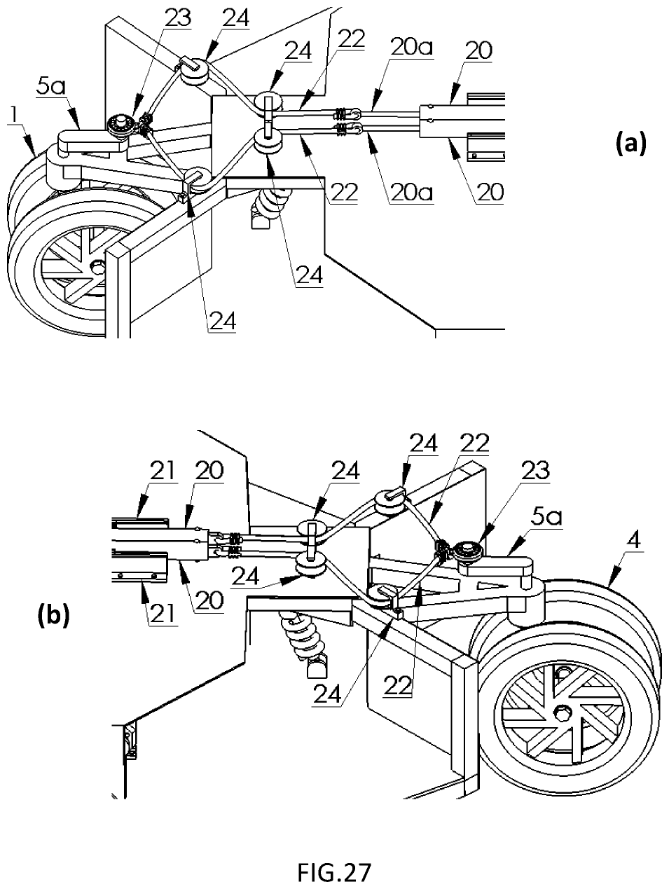

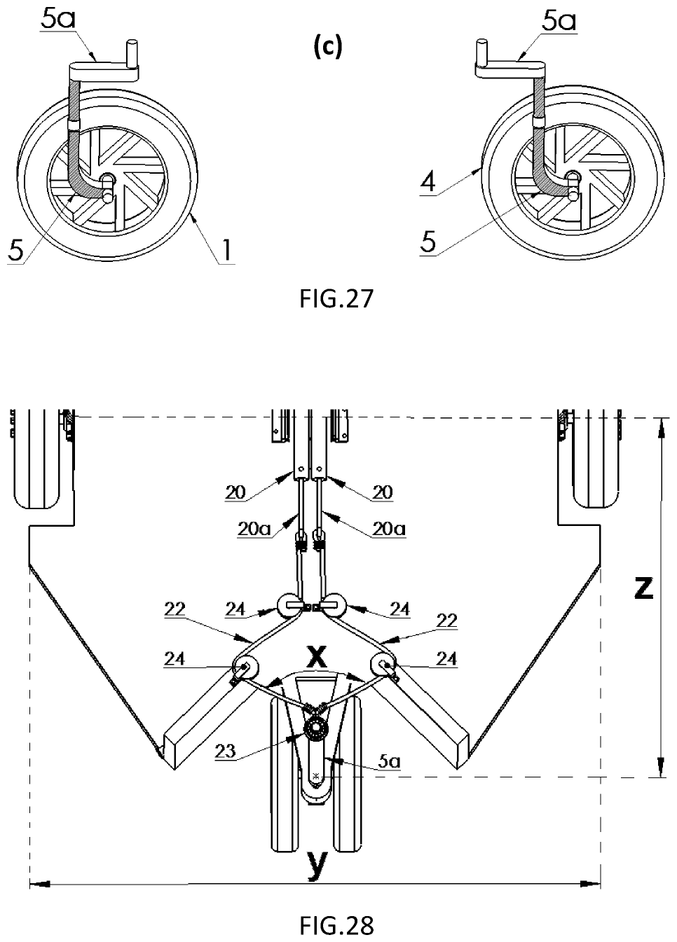

The hydraulic pumps (19) affect in the direction of closing of the hydraulic piston rods (20a). In FIGS. 25 and 26, force is transmitted from the end of the hydraulic piston rods (20a) to the front-rear wheel steering handle (5a) for the front wheel (1). For the rear wheel (4), force is transmitted from the body end of the hydraulic cylinders (20) to the front-rear wheel steering handle (5a). We will focus on these two different situations in FIG. 27.

The rope (22) connected to the end of the hydraulic piston rod (20a) and connected to the end of the hydraulic cylinders' (20) body is a durable and flexible material. The piece with bearing (23) is mounted on the vertical rod of the front-rear wheel steering handle (5a), and it (23) can easily rotate around the rod and it (23) has a separate ring-extension for connection to the rope (22). The other side of the front-rear wheel steering handle (5a) is fixed to the end of the vertical rod of the front-rear wheel mounting support (5) from the portion remaining on the front-rear wishbone (6). It is a mechanically durable and strong material. It operates in the crank handle function. That is, if the front-rear wheel steering handle (5a) is rotated by holding the piece with bearing (23), the direction of the front wheel (1) or rear wheel (4) changes in the same way. An important detail of this is that the front-rear wheel mounting support (5) has a vertical to horizontal inclination. Therefore, the fixing position of the front-rear wheel steering handle (5a) to the front-rear wheel mounting support (5) at the front wheel (1) side and the fixing position of the front-rear wheel steering handle (5a) to the front-rear wheel mounting support (5) at the rear wheel (4) side is different from each other. In FIG. 27-c, this difference is illustrated.

In FIG. 27a, rope (22) is connected to the hydraulic piston rod (20a). The other end of the rope (22) is connected to the piece with bearing (23). Thus, the pulling force generated at the end of the hydraulic piston rod (20a) reaches the piece with bearing (23). However, these forces must be applied to the piece with bearing (23) in an angled (x) position. For this purpose, the pulleys (24) which are fixed to the vehicle body (8) at specified points take part in the transmission of force via the rope (22) over the desired path. As a result, the force received from the end of the two separate hydraulic piston rods (20a) is applied to the piece with bearing (23) in an angled (x) position. With the vectoral sum of these two forces, the front-rear wheel steering handle (5a) will be pulled and the front wheel (1) will be pressed in the direction of travel. A similar application is shown in FIG. 27b. This time, the force taken from the end of the hydraulic cylinder's (20) body will be transferred with similar elements, causing the rear wheel (4) to be pressed in the direction of movement.

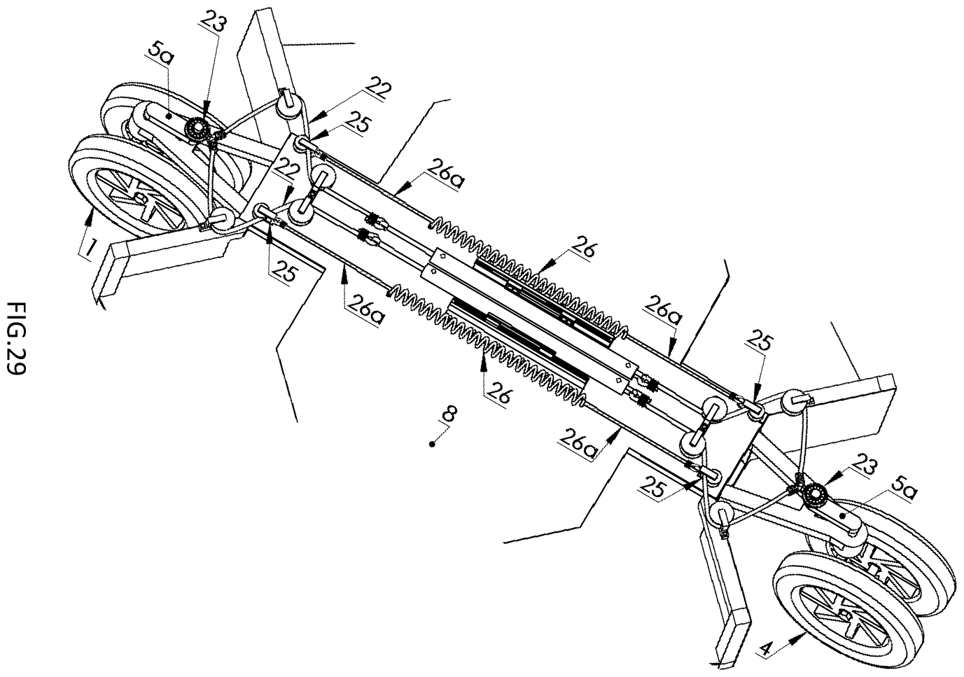

In FIG. 28, the distance between the center points of the side wheels (2,3) is briefly defined as the vehicle width (y). The distance between the shaft axis of the side wheels (2,3) and the vertical rod of the front-rear wheel mounting support (5) is briefly defined as the vehicle half-length (z).

In FIG. 28, we will examine the detail of the connection of two separate ropes (22) to the piece with bearing (23) at a single point and angled (x) position. As the vehicle moves forward, these two ropes (22) will apply a pulling force to the piece with bearing (23). The total force applied to the piece with bearing (23) is the vectoral sum of the forces on the rope (22). In the vector sum of these forces, the angle (x) between them is important.

The vector sum of the pulling forces formed on the two ropes (22) must be in the opposite direction to the direction of movement of the vehicle, so that the front wheel (1) and/or the rear wheel (4) are pressed by the front-rear wheel steering handle (5a) in the direction of vehicle movement. To ensure this relationship, the connection angle (x) of the rope (22) is important. We can analyze other important details as follows. The mechanical connection of the hydraulic system gives the following result: the pulling force generated on the rope (22) that is on the right side of the vehicle is directly proportional to the rotation speed of the right wheel (3), the pulling force generated on the rope (22) that is on the left side of the vehicle is directly proportional to the rotation speed of the left wheel (2). At the same time, since the difference in the rotation speed of the left wheel (2) and the right wheel (3) determines the vehicle cornering, the forces generated on the two ropes (22) are directly related to the vehicle speed and cornering. In order to establish this relation and operate the system as described, the angle (x) between the two ropes (22) has a mathematical relationship to the vehicle width (y) and the vehicle half-length (z). Briefly, what is described in FIG. 28 is that the angle (x) between two ropes (22) is not random value; it is determined as a result of mathematical calculation depending on vehicle width (y) and vehicle half-length (z). In this way, the pulling forces that will occur on the rope (22) during the cornering of the vehicle press the front wheel (1) and/or the rear wheel (4) in the direction of the cornering angle.

Due to vehicle direction change and when the vehicle is at low speeds, there will be more elongation and retraction change on the rope (22). In order to prevent the rope (22) from running around in this case, for it to be more regular, and also for the rope (22) to rapidly extend and shorten during rapid rotations of the front-rear wheel steering handle (5a), a number of elements has been installed. FIG. 29 illustrates the assembly of these elements.

Unlike the pulley (24) fixed to the vehicle body (8), the mobile pulley (25) can move in the direction of the forces to which it is subjected. The two spring (26) used are mounted in tensioned way and tend to contract. The spring (26) will apply a pulling force between the ends on two separate sides.

Although spring's rope (26a) is a flexible material such as the rope (22), it will be less than rope (22) in terms of the force it will carry and this product (26a) is separated from rope (22) in terms of the durability parameter. It does not need to be as durable as the rope (22). Each spring (26) is connected to two mobile pulleys (25) by spring's rope (26a). The Spring's rope (26a) transmits the pulling force on the Spring (26) to the mobile pulley (25). Thus, the mobile pulley (25) will always apply a pulling force on the rope (22). This force is of low value since it will only be involved in the collection of the rope (22). In particular, it remains insignificant when compared to the forces generated by the hydraulic cylinders (20). Two springs (26) and four spring's ropes (26a) to be used here are in symmetrical form for left and right side. Their structural and geometrical forms are identical.

FIG. 30 is a schematic drawing of the hydraulic system. The lines between the elements indicate the hoses through which the hydraulic oil will flow. Two hydraulic pumps (19) and two hydraulic cylinders (20) shown here symbolically are the elements expressed in the previous drawings. While the filter (28) protects the system components by cleaning the hydraulic oil, the reservoir (29) is the container where the hydraulic oil will be accumulated and the required oil will be taken. These are the fundamental hydraulic elements needed for the operation of the system. As FIG. 30 is a schematic drawing, the indicated elements are presented symbolically.

In the fixed throttle valve (27), the hydraulic oil has to pass through a narrow space. This results in hydraulic pressure in the previous part where it comes from. This pressure is directly proportional to the amount of oil the hydraulic pump 19 will pump per unit time. And the resulting pressure acts directly on the closing direction of the hydraulic cylinders (20).

In order for the hydraulic system to function correctly, two Hydraulic pumps (19) must have the same displacement value and the mechanical transmission ratio (gear ratio) taken for pumps (19) over the shafts rotating the side wheels (2,3) must have the same value. Two fixed throttle valves (27) must be in the same form and structure. Throttling must be done equally on the fixed throttling valves (27). In addition, two hydraulic cylinders (20) must have the same physical dimensional values and structure. In short, the hydraulic cylinders (20) must have equal pressure when the vehicle is driven straight. These are necessary for proper operation of the hydraulic system.

The hydraulic system may include a passive or active cooling unit when required.

As the vehicle accelerates to high speeds, with the hydraulic system's contribution the four wheels are used to control the direction of the vehicle. This will provide better gripping on the road and vehicle control.

FIG. 1 shows the different versions of the vehicle. Since it covers all the versions, the hydraulic system is described with version in FIG. 1a, and some changes are applied on the hydraulic system in versions shown in FIG. 1b and FIG. 1c. Depending on whether the front wheel (1) or rear wheel (4) is absent, the body of the two hydraulic cylinders (20) is fixed onto the vehicle body (8) on side where these wheels (1,4) are absent. Linear rail (21) is not used. The forces to be taken from the end of the two separate hydraulic piston rods (21a) with the rope (22) are conveyed in the same way to the piece with bearing (23) at an angled (x) position with the help of pulley (24). Spring's ropes (26a) are also fixed in the same way, depending on the absence of the front wheel (1) or the rear wheel (4), they (26a) are fixed to the vehicle body (8) from the side where the wheels (1,4) are not present. Other parts are the same. The hydraulic system can operate in the vehicle versions of FIGS. 1b and 1c with the same logic and elements.

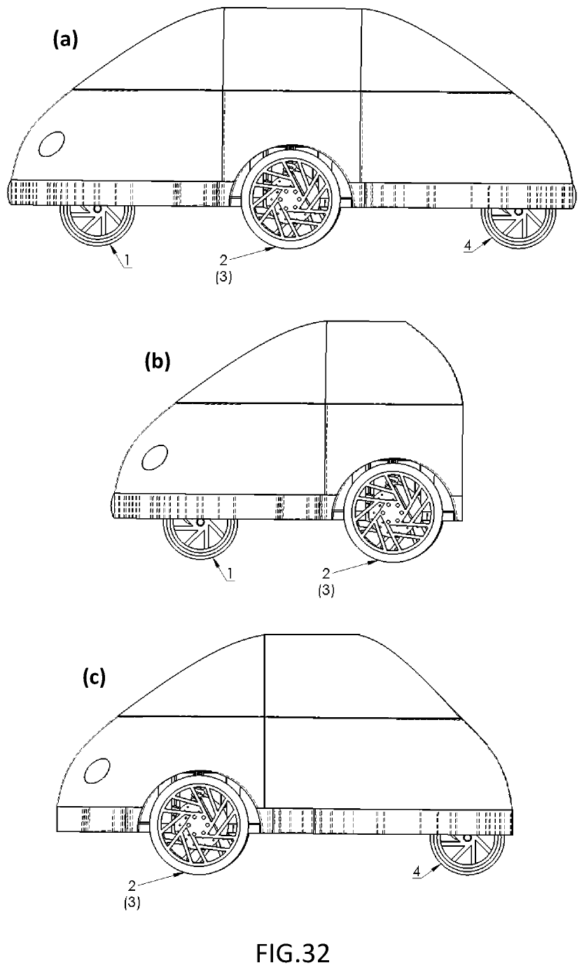

Set of side views are schematically shown for alternative vehicle versions to which the invention can be applied in the FIG. 32. The schematic drawing of the transportation vehicle shown here can be applied for vehicles of other purposes.

1. The invention is the full control of the vehicle motion and it has;
electric motor 1 (13) whose main function is to provide forward-backward motion of the vehicle, it has a double shaft, one of which is mounted to speed reducer (12) and the other shaft is mounted to AR input 1 (14a),
electric motor 2 (15) whose main function is to provide right-left cornering of the vehicle and it is mounted on AR input 2 (14b),
Addition reducer (14) which is used to change the side wheel speed in accordance with the speed of electric motor 2 (15),
speed reducer (12) which is used because speed is changed from AR input 1 (14a) to AR output (14c) and it (12) provides the same speed change on the other side wheel, and in addition, it has the same gear ratio as the gear ratio from AR input 1 (14a) to AR output (14c),
control unit (16) that adjusts the speed control of electric motor 1 (13) and electric motor 2 (15) in accordance with driving control data (17),
hydraulic system that is used in the direction control of the front wheel (1) and/or rear wheel (4).

2. Full control of the vehicle motion according to claim 1, wherein Addition reducer (14) further comprises;
AR input 1 (14a) and AR input 2 (14b) shafts used as entry for Addition reducer (14) and AR output (14c) shaft that is used as output for Addition reducer (14),
the AR sun gear (14l) fixed to the AR input 1 (14a) shaft, AR worm gear (14m) fixed to the shaft of the AR input 2 (14b), and AR cylinder (14f) fixed to the shaft of the AR output (14c),
AR worm wheel (14j) which mechanically interacts with the AR worm gear (14m) and provides the orbital positional changes to AR planet carrier (14h) and AR planet carrier rod (14i), which are fixed on itself (14j), around AR input 1 (14a) with the rotational force it receives from the place of interaction with AR worm gear (14m),
the gear ratio between AR worm gear (14m) and AR worm wheel (14j) is higher than 3:1,
AR cylinder bearing hole (14g), which is a part of AR cylinder (14f) and intended for the mounting of one side of AR input 1 (14a) shaft via AR bearing (14e), and AR ring gear (14n), which is the another part of AR cylinder (14f) and formed to create mechanical interaction with AR planet gears (14k),
AR planet carrier (14h) used for providing mounting support to AR planet carrier rod (14i) and used to change the orbital positions of AR planet gears (14k) in a controlled manner as it fixed to AR worm wheel (14j),
AR planet carrier rod (14i) functioning as mounting parts of AR planet gears (14k),
AR support rod (14p) which increases the stability of the mechanical connection between two AR planetary carriers (14h) and it (14p) can use optional,
AR planet gears (14k) which are mounted on AR planet carrier rod (14i) and can rotate around this rod (14i) owing to its bearing cone, and providing the transmission of rotational motion energy coming from both AR input 1 (14a) and AR input 2 (14b) to AR ring gear (14n) over itself (14k),
AR body (14d) which serves as the body for the mechanism in the Addition reducer (14).

3. Full control of the vehicle motion according to claim 1, wherein alternative version Addition reducer (14) further comprises;
AR input 1 (14a) and AR input 2 (14b) shafts used as entry for alternative version Addition reducer (14) and AR output (14c) shaft that is used as output for alternative version Addition reducer (14),
the AR sun gear (14l) fixed to the AR input 1 (14a) shaft, AR worm gear (14m) fixed to the shaft of the AR input 2 (14b), and AR planet carrier (14h) fixed to the shaft of the AR output (14c),
AR worm wheel (14j) which has mechanical contact with AR worm gear (14m) and transferring the rotational force it gets from here (14m) to AR planet gears (14k) through AR ring gear (14n),
the gear ratio between AR worm gear (14m) and AR worm wheel (14j) is higher than 3:1,
AR ring gear (14n) which is fixed into the inner side of AR worm wheel (14j) or it is defined as inner side of AR worm wheel (14j) that has compatible threaded contacts with AR planet gears (14k),
AR planet carriers (14h) which are fixed on AR output (14c) and used for providing mounting support to AR planet carrier rod (14i),
AR planet carrier rod (14i) functioning as mounting parts of AR planet gears (14k),
AR support rod (14p) which increases the stability of the mechanical connection between two AR planetary carriers (14h) and it (14p) can use optional,
AR planet gears (14k) which are mounted on AR planet carrier rod (14i) and can rotate around this rod (14i) owing to its bearing cone and can change their (14k) position according to the rotation of AR ring gear (14n) and AR sun gear (14l),
to the cylindrical-shaped AR ring gear support (14s) extending to the two sides of the AR ring gear (14n),
AR support bearing (14u) that operates by being mounted between AR planetary carrier (14h) and AR ring gear support (14s),
AR circlip channel (14t) that is necessary for the mounting of AR support bearing (14u) and AR circlip (14v) that is fitted here (14t),
AR body (14d) which serves as the body for the mechanism in the alternative version Addition reducer (14).

4. Full control of the vehicle motion according to claim 1, wherein hydraulic system further comprises;
two hydraulic pumps (19) of the same specification used to create hydraulic pressure in the system,
belt pulley with one-way bearing (18), belt (18a), and Belt pulley (18b), which are used to receive power from the shafts that rotate the side wheels (2,3) to two hydraulic pumps (19),
two identical hydraulic cylinders (20) and their parts hydraulic piston rod (20a) that are used to generate a pulling force from hydraulic pressure,
the rope (22) with flexible quality, which is used to transmit the generated pulling force,
piece with bearing (23), which allows the rope (22) to be appropriately-ideally connected to the front-rear wheel steering handle (5a),
the front-rear wheel steering handle (5a), which acts as the crank handle of the front-rear wheel mounting support (5), to change the direction of the front wheel (1) and/or the rear wheel (4),
pulleys (24) which are used to transmit the pulling force formed on the rope (22) over the targeted path,
springs (26), spring's ropes (26a) and mobile pulleys (25) which are used for rope (22) to move regularly,
two identical fixed throttle valves (27) which function in the generation of hydraulic pressure,
filter (28) and reservoir (29) which are other essential elements required by hydraulic system to perform the described operations.
